(19) United States
(12) Patent Application Publication
(10) Pub. No.: US 2020/0255154 A1
(43) Pub. Date: Aug. 13, 2020

(54) DEFROSTING DEVICE, DEFROSTING INSTALLATION AND METHOD FOR CONFIGURING A DEFROSTING INSTALLATION

(71) Applicant: COMMISSARIAT A L'ENERGIE ATOMIQUE ET AUX ENERGIES ALTERNATIVES, Paris (FR)

(72) Inventors: Christian BOLZMACHER, Montrouge (FR); Edouard LEROY, Paris (FR); Adao DELEHELLE, Gazeran (FR)

(73) Assignee: COMMISSARIAT A L'ENERGIE ATOMIQUE ET AUX ENERGIES ALTERNATIVES, Paris (FR)

(21) Appl. No.: 15/780,809

(22) PCT Filed: Dec. 5, 2016
(86) PCT No.: PCT/FR2016/053205

§ 371 Date: Jun. 1, 2018

(30) Foreign Application Priority Data
Dec. 17, 2015 (FR) 1562637

(51) Int. Cl. B64D 15/16; H02N 2/02; H02N 2/04; H02N 2/06

(52) U.S. Cl. CPC B64D 15/163; H02N 2/026; F02C 7/04; H02N 2/065; H02N 2/043

(57) ABSTRACT

A defrosting device includes an actuator including: a stationary portion and a movable portion configured to alternately move away from and move towards the stationary portion, and an intermediate element including a loading portion configured to be pushed by the movable portion of the actuator when the movable portion of the actuator moves away from the stationary portion, and a movement transmission portion configured to move according to the movement of the loading portion and to push a part to be defrosted to deform the part to be defrosted. The movable portion of the actuator and the loading portion of the intermediate element are not connected to one another, such that the loading portion of the intermediate element cannot pull the movable portion of the actuator to move same away from the stationary portion.

The present invention relates to a defrosting device, a defrosting installation and a method for configuring a defrosting installation.

The invention applies more particularly to a defrosting device comprising:
an actuator having a stationary portion and a movable portion designed to alternately move away from and move towards the stationary portion,
an intermediate element comprising:
   a loading portion arranged to be pushed by the movable portion of the actuator when the movable portion of the actuator moves away from the stationary portion, and
   a movement transmission portion designed to move according to the movement of the loading portion and intended to push a part to be defrosted to deform the part to be defrosted.

For example, the English patent application published under the number GB 2 472 053 A describes a defrosting device as defined above.

The actuator comprises a piezoelectric stack and the intermediate element is a movement amplifier comprising a lever mechanism secured firstly to the actuator and secondly to the part to be defrosted.

The inventors found that the actuator of a defrosting device as described in the document GB 2 472 053 A was quickly damaged, after a small number of uses.

It may thus be desired to provide a defrosting device that makes it possible to overcome at least some of the aforementioned problems and constraints.

A defrosting device is therefore proposed, comprising:
an actuator having a stationary portion and a movable portion designed to alternately move away from a move towards the stationary portion,
an intermediate element comprising:
   a loading portion arranged to be pushed by the movable portion of the actuator when the movable portion of the actuator moves away from the stationary portion, and
   a movement transmission portion designed to move according to the movement of the loading portion and intended to push a part to be defrosted to deform the part to be defrosted,
      the movable portion of the actuator and the loading portion of the intermediate element not being connected to one another, such that the loading portion of the intermediate element cannot pull the movable portion of the actuator so as to move same away from the stationary portion.

By virtue of the invention, the actuator cannot be pulled by the intermediate element. Thus, if the actuator is fragile when it is loaded under traction, as is the case for example with piezoelectric actuators, the risk of damage is reduced.

Optionally, the intermediate element is a movement amplifier designed so that the movement transmission portion reproduces, in an amplified manner, the movement of the loading portion.

Optionally also, the actuator comprises a piezoelectric structure designed to deform in response to an electrical signal so as to move the movable portion of the actuator with respect to the stationary portion.

Optionally also, the movable portion of the actuator comprises a rounded face intended to push the loading portion of the intermediate element.

Optionally also, the defrosting device further comprises a device controlling the actuator designed so as to alternately make the movable portion of the actuator move away from and towards the stationary portion at a frequency sweeping a predetermined range of frequencies at least once in the course of time.

Optionally also, the range of frequencies is swept in a decreasing manner.

A defrosting installation is also proposed, comprising:
a part to be defrosted,
an actuator having a stationary portion and a movable portion designed to alternately move away from and move towards the stationary portion, the movable portion of the actuator being arranged so as, when it moves away from the stationary portion, to push a loading portion of the part to be defrosted in order to deform the part to be defrosted,
   the movable portion of the actuator and the loading portion of the part to be defrosted not being connected to one another, such that the loading portion of the part to be defrosted cannot pull the movable portion of the actuator in order to move it away from the stationary portion.

Optionally, the actuator comprises a piezoelectric structure designed so as to deform in response to an electrical signal in order to move the movable portion of the actuator with respect to the stationary portion.

Optionally also, the movable portion of the actuator comprises a rounded face intended to push the loading portion of the part to be defrosted.

Optionally also, the installation further comprises a device controlling the actuator designed to alternately make the movable portion of the actuator move away from and towards the stationary portion at a frequency sweeping a predetermined range of frequencies at least once in the course of time.

Optionally also, the range of frequencies is swept in a decreasing manner.

A method for configuring a defrosting installation according to the invention or a defrosting installation comprising a part to be defrosted and a defrosting device according to the invention is also proposed, the method comprising:
determining modal frequencies of eigenmodes of the part to be defrosted,
selecting at least one of the modal frequencies,
determining a range of frequencies comprising the modal frequency or frequencies selected, but not the modal frequencies lower than the smallest selected modal frequency or greater than the highest selected modal frequency,
configuring the control device so as to be able to control the actuator so as to alternately move the movable portion of the actuator away from and towards the stationary portion at a frequency sweeping the range of frequencies at least once in the course of time.

The invention will be understood better by means of the following description given solely by way of example and made with reference to the accompanying drawings, in which:

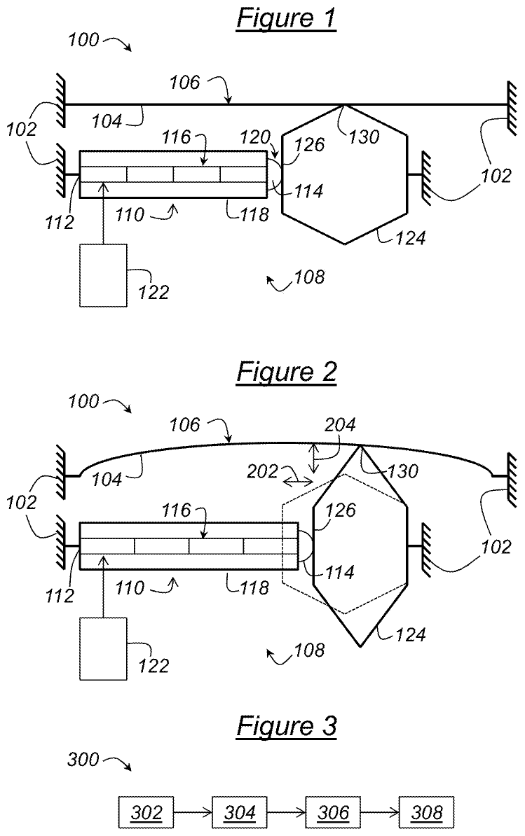

FIG. 1 shows schematically the general structure of a defrosting installation, according to one embodiment of the invention,

FIG. 2 shows schematically the general structure of the defrosting installation of FIG. 1 during operation thereof,

FIG. 3 illustrates the successive steps of a method for configuring the defrosting installation of FIG. 1, according to one embodiment of the invention,

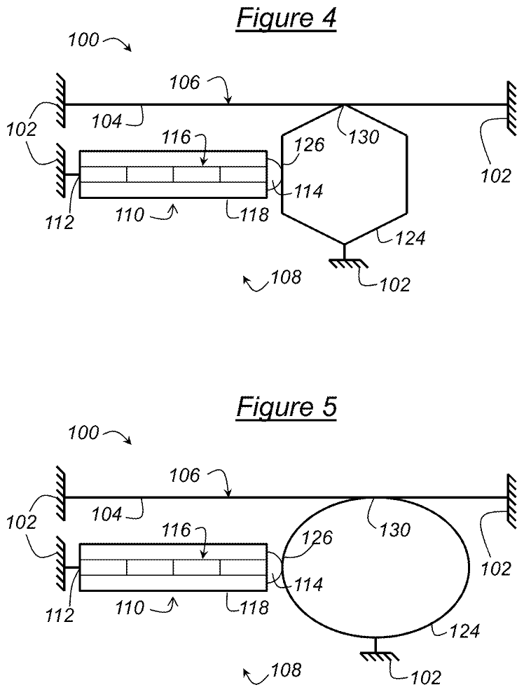

FIGS. 4 to 10 show schematically the general structure of defrosting installations according to other embodiments of the invention,

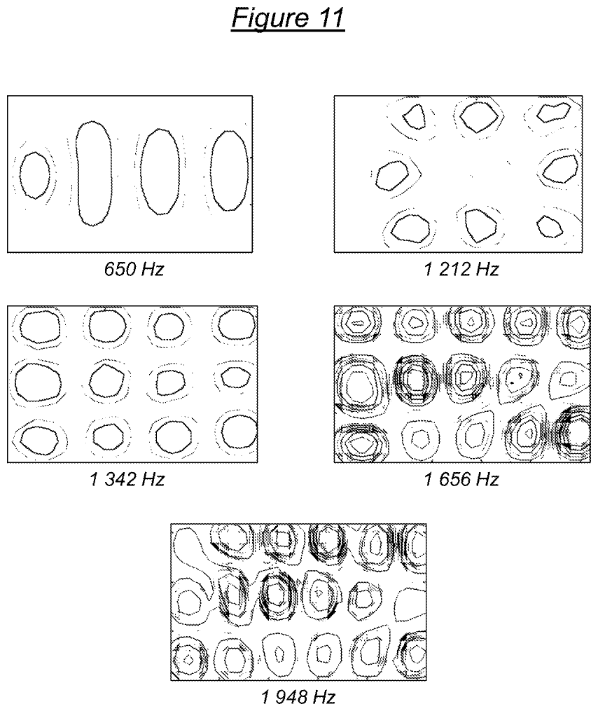

FIG. 11 shows deformations of a panel to be defrosted of the installation of FIG. 1, for various eigenmodes of the panel.

With reference to FIG. 1, a defrosting installation 100 illustrating a non-limitative example of implementation of the invention will now be described.

The installation 100 comprises first of all a frame 102.

The installation 100 further comprises a panel 104 secured to the frame 102 by its edges so as for example to achieve an embedding of the panel 104. The panel 104 has a face 106 liable to be covered with frost.

In the example described, the panel 104 is flat, but the invention can also apply to curved panels or even to other forms of parts other than a panel. The panel 104 for example forms part of an aircraft wing or of a nacelle of an aircraft (that is to say a cage enclosing an engine of the aircraft, generally situated under a wing), or of an evaporator in a motor vehicle engine. The panel 104 is for example formed by a rectangular aluminum plate 1 mm thick. The panel 104 has for example a length of 300 mm and a width of 200 mm.

The installation 100 further comprises at least one device 108 for defrosting the panel 104.

The defrosting device 108 comprises first of all an actuator 110 comprising a stationary portion 112 secured to the frame 102. The actuator 110 further comprises a movable portion 114 designed so as to alternately move away from and towards the stationary portion 112.

In the example described, the movable portion 114 moves linearly over a straight line passing through the stationary portion 112. Furthermore, the actuator 110 has a general elongate shape having two ends forming respectively the stationary portion 112 and the movable portion 114 of the actuator 110.

The actuator 110 comprises first of all a piezoelectric structure 116 designed to deform in response to an electrical signal in order to move the movable portion 114 with respect to the stationary portion 112. The piezoelectric structure 116 has, in the absence of an electrical signal, a certain idle length.

In the example described, the piezoelectric structure 116 comprises a plurality of piezoelectric elements stacked in the direction of the length of the actuator 110.

The actuator 110 further comprises a device 118 for compressing the piezoelectric structure 116 so that, in the absence of any electrical loading, the piezoelectric structure 116 has a length, referred to as the initial length, less than its idle length.

The actuator 110 further comprises a strut which, in the example described, is secured to the compression device 118 and forms the movable portion 114 of the actuator 116. The strut has a rounded face 120. The strut is for example produced from hard plastics material.

The defrosting device 108 further comprises a device 122 for controlling the actuator 110. The control device 122 is designed to alternately make the movable portion 114 of the actuator 110 move away from and towards the stationary portion 112 at a desired frequency, this frequency varying over time as will be explained hereinafter.

In the example described, the control device 122 is designed so as to supply an electrical signal to the piezoelectric structure 116 so that its length varies at the desired frequency, between two longer lengths, the smallest of which is greater than or equal to the initial length defined by the compression device 118. For example, the smallest of these two lengths is equal to the initial length. The largest of these two lengths is preferably less than the idle length of the piezoelectric structure 116.

The defrosting device 108 further comprises a movement amplifier 124 interposed between the actuator 110 and the panel 104. The movement amplifier 124 comprises first of all a loading portion 126 in contact with the movable portion 114 of the actuator 110. Thus the movable portion 114 of the actuator 110 is arranged to push the loading portion 126 of the movement amplifier 124 when this movable portion 114 moves away from the stationary portion 112.

The movement amplifier 124 further has a movement transmission portion 130 in contact with the panel 104. The movement amplifier 124 is designed so that the movement transmission portion 130 reproduces the movement of the loading portion 126 in an amplified manner. Thus the movement transmission portion 130 is arranged to push the panel 104 in order to deform the panel 104 and thus defrost its surface 106.

The movement amplifier 124 comprises for example a lever mechanism for performing the movement amplification, comprising at least one lever arm. Each lever arm has a pivot point produced either by a mechanical connection or, as is the case in the example in FIG. 1, by mechanical deformation of a part of the movement amplifier 124.

In the example described, the movement transmission portion 130 of the movement amplifier 124 is arranged so as to push the panel 104 perpendicularly to this panel 104. Furthermore, the movement transmission portion 130 is secured to the panel 104.

According to the invention, the movable portion 114 of the actuator 110 and the loading portion 126 of the movement amplifier 124 are not connected to one another, so that the loading portion 126 of the movement amplifier 124 cannot pull the movable portion 114 of the actuator 110 in order to move it away from the stationary portion 112.

Moreover, it will be appreciated that, in the example described, the loading portion 126 of the movement amplifier 124 is in contact with the rounded face 120 of the strut, which assists punctiform contact between the two parts. Punctiform contact reduces the risks of damage to the actuator 110 when the latter is poorly aligned with the movement amplifier 124.

In the example in FIG. 1, the movement amplifier 124 comprises a hexagonal structure having six sides. One of the six sides forms the loading portion 126. The side opposite to the loading portion 126 is secured to the frame 102. The movement transmission portion 130 is formed by a vertex connected to the loading portion 126 by just one side of the hexagon.

With reference to FIG. 2, an example of functioning of the installation 100 in FIG. 1 will now be explained.

When the control device 122 supplies an electrical signal to the piezoelectric structure 116, the latter elongates with respect to its initial length. This elongation causes the separation of the movable portion of the actuator 110 by a distance 202 with respect to its stationary portion 112. The movable portion 114 of the actuator 110 pushes the loading portion 126 of the movement amplifier 124, which deforms and causes the movement of the movement transmission portion 130 by a distance 204 greater than the distance 202. The panel 106 is thus pushed by the movement transmission portion 130 and deforms while being raised by the distance 204.

When the electrical signal decreases, or even disappears, the piezoelectric structure 116 retracts to its initial length. The panel 104 and the movement amplifier 124 are, because of their deformation, recalled to their initial state.

Thus, by varying the electrical signal at a certain frequency, it is possible to make the panel 104 vibrate at this frequency. If the vibration frequency is close to a modal frequency of an eigenmode of the panel 104, it may happen that the latter deforms more than the distance 204 provided for by the functioning of the actuator 110. The panel 104 draws with it the movement transmission portion 130 of the movement amplifier 124, so that the loading portion 126 of the movement amplifier 124 moves by a distance greater than the distance 202 provided by the functioning of the actuator 110. In this case, because the loading portion 126 of the amplifier 124 is not connected to the movable portion 114 of the actuator 110, the loading portion 126 of the amplifier 124 separates from the movable portion 114 of the actuator 110 without pulling it. Thus the actuator 110 is not subjected to a traction that would risk damaging it.

With reference to FIG. 3, an example of a method for configuring the installation of FIG. 1 will now be described.

During a step 302, a modal analysis of the panel 104 while it is secured to the frame 102 is carried out in order to determine modal frequencies of eigenmodes of the panel 104. This modal analysis can be carried out with the defrosting device 108 fitted, or without the defrosting device 108. This is because the inventors found that the modal frequencies generally did not vary a great deal between the two cases.

During a step 304, at least one of the modal frequencies determined is selected. Preferably the modal frequencies selected are those associated with eigenmodes of the panel 104 in which all the antinodes are separated from each other by a wavelength of between 1 cm and 10 cm. Preferably, at least one of the modal frequencies selected is associated with an eigenmode in which all the antinodes are separated from one another by a wavelength of between 1 cm and 5 cm, for example between 1 cm and 3 cm, and at least one other of the modal frequencies selected is associated with an eigenmode in which all the antinodes are separated from one another by a wavelength of between 5 cm and 10 cm, for example between 8 cm and 10 cm.

Alternatively, the modal frequencies selected are those associated with eigenmodes of the panel 104 having at least ten antinodes (regions of maximum deformation amplitude) separated from one another by nodes (regions of minimum deformation amplitude), preferably at least 12 antinodes.

During a step 306, a range of frequencies is determined comprising the modal frequency or frequencies selected, but not the modal frequencies lower than the smallest selected modal frequency or higher than the greatest selected modal frequency. In the case of the panel 104 with the dimensions indicated previously, the frequency range extends: preferably over less than 2,000 Hz, preferably again over less than 1,000 Hz; below 20,000 Hz, preferably again below 4,000 Hz; and above 500 Hz, preferably again above 1,000 Hz. These values can be extended to other panel geometries.

With reference to FIG. 11, the deformations of the panel 104 with the dimensions indicated previously by way of example are illustrated for five modal frequencies: 650 Hz, 1,212 Hz, 1,342 Hz, 1,656 Hz and 1,948 Hz. It appears that, at the first two modal frequencies, the eigenmodes of the panel 104 comprise respectively only four and eight antinodes, while the other three eigenmodes of the panel 104 comprise respectively twelve, fifteen and eighteen antinodes. Thus the frequency range comprises the frequencies 1,342 Hz, 1,656 Hz and 1,948 Hz, but not the frequencies 650 Hz and 1,212 Hz. The frequency range chosen extends for example from 1,300 Hz to 2,000 Hz.

Returning to FIG. 3, during a step 308, the control device 122 is configured so as to be able to control the actuator 110 at a vibration frequency sweeping the frequency range in a decreasing manner at least once in the course of time, that is to say starting with the highest frequencies. The inventors found in fact that the defrosting was more effective when the sweeping was carried out in a decreasing manner. More precisely, the eigenmodes having small wavelengths are excited first. However, the short wavelengths are those causing the greatest twisting of the panel 104, which allows significant preliminary detachment of the frost and in particular breaking of the frost. The eigenmodes having the longest wavelengths are next excited. However, the long wavelengths do not produce twisting as great as previously, but on the other hand a higher movement amplitude, which makes it possible to effectively complete the detachment of the frost.

The sweeping speed is preferably between 1,000 Hz/s and 2,000 Hz/s, for example around 1,500 Hz/s. Thus the power density per frequency increases, which improves the efficacy of the defrosting. Furthermore, the sweeping time is preferably between 0.1 s and 1.5 s, for example around 0.5 s.

Subsequently, whenever the panel 104 is to be defrosted, the control device 122 is activated and controls the actuator 110 as indicated above, so that the defrosting device 108 makes the panel 104 vibrate at the vibration frequency that sweeps the frequency range in a decreasing manner in the course of time, which causes the defrosting of the surface 106 of the panel 104.

With reference to FIG. 4, in another embodiment, the movement amplifier 124 is identical to the one in FIG. 1, except that it is the vertex opposite to the movement transmission portion 130 that is secured to the frame 102.

With reference to FIG. 5, in another embodiment, the movement amplifier 124 is in the form of an ellipse. A portion of the ellipse having the greatest concavity forms the loading portion 126, while a portion of the ellipse having the smallest concavity forms the movement transmission portion 130. The other portion of the ellipse having the smallest concavity is fixed to the frame 102.

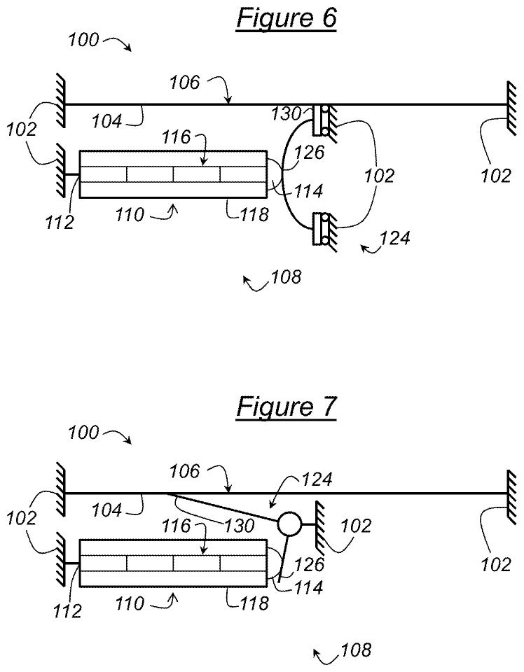

With reference to FIG. 6, in another embodiment, the movement amplifier 124 comprises a curved part having two ends arranged so as to slide with respect to the frame 102 perpendicular to the direction of movement of the movable portion 114 of the actuator 110. The loading portion 126 is formed by the center of the curved part, while the movement transmission portion is formed by one of the two ends of the curved part. When the movable portion 114 of the actuator 110 pushes the center of the curved part, the latter flattens and the movement transmission portion 130 slides along the frame 102 in order to push the panel 104. In a variant, the end opposite to the movement transmission portion 130 could be fixed to the frame 102, rather than being mounted so as to slide with respect to the latter.

With reference to FIG. 7, in another embodiment, the movement amplifier 124 comprises a first-class lever, that is to say one having a pivot point situated between the loading portion 126 and the movement transmission portion 130.

With reference to FIG. 8, in another embodiment, the movement amplifier 124 comprises a third-class lever, that is to say one having a pivot point situated so that the loading portion 126 is situated between this pivot point and the movement transmission portion 130.

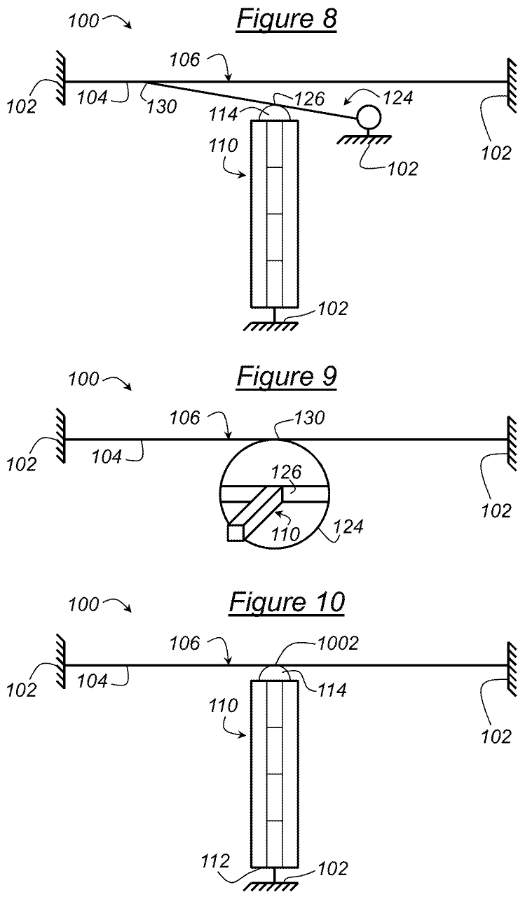

With reference to FIG. 9, in another embodiment, the movement amplifier 124 comprises a circle and a band connecting two portions of the circle. One of the two arcs of a circle extending from one end to the other of the band forms the movement transmission portion 130 and is secured to the panel 104. The loading portion 126 is formed by the band and, when the movable portion 114 of the actuator 110 pushes the band, the latter bends so that its two ends approach one another, which curves the arc of a circle forming the movement transmission portion 130, which in return pushes the panel 104.

With reference to FIG. 10, in another embodiment, the defrosting device 108 does not comprise any movement amplifier. In this case, the movable portion 114 of the actuator 110 is directly in contact with a loading portion 1002 of the panel 104 in order to push the latter. The movable portion 114 of the actuator 110 is not connected to the loading portion 1002 of the panel 104, so that the panel 104 cannot pull this movable portion 114 of the actuator, for example when it is resonating.

It clearly appears that a defrosting installation and/or device as described previously makes it possible to protect the actuator against stretching that could damage it.

It should be noted moreover that the invention is not limited to the embodiments described above. It will be clear in fact to a person skilled in the art that various modifications can be made to the embodiments described above, in the light of the teaching that has just been disclosed to him.

For example, the actuator 110, which is of the piezoelectric type in the examples described, could be replaced by other types of actuator such as a magnetostrictive actuator or an electromagnetic actuator.

In the following claims, the terms used must not be interpreted as limiting the claims to the embodiments disclosed in the present description, but must be interpreted in order to include therein all the equivalents that the claims aim to cover because of their wording and the prediction of which is within the capability of a person skilled in the art by applying their general knowledge to the implementation of the teaching that has just been disclosed to them.

1-12. (canceled)

13: A defrosting device, comprising:
an actuator including a stationary portion and a movable portion configured to alternately move away from and move towards the stationary portion;
an intermediate element comprising:
a loading portion configured to be pushed by the movable portion of the actuator when the movable portion of the actuator moves away from the stationary portion, and
a movement transmission portion configured to move according to the movement of the loading portion and to push a part to be defrosted to deform the part to be defrosted;
wherein the movable portion of the actuator and the loading portion of the intermediate element are not connected to one another, such that the loading portion of the intermediate element cannot pull the movable portion of the actuator to move same away from the stationary portion.

14: The defrosting device as claimed in claim 13, wherein the intermediate element is a movement amplifier configured so that the movement transmission portion reproduces, in an amplified manner, movement of the loading portion.

15: The defrosting device as claimed in claim 13, wherein the actuator comprises a piezoelectric structure configured to deform in response to an electrical signal to move the movable portion of the actuator with respect to the stationary portion.

16: The defrosting device as claimed in claim 13, wherein the movable portion of the actuator comprises a rounded face configured to push the loading portion of the intermediate element.

17: The defrosting device as claimed in claim 13, further comprising a device controlling the actuator configured to alternately make the movable portion of the actuator move away from and towards the stationary portion at a frequency sweeping a predetermined range of frequencies at least once in the course of a time.

18: The defrosting device as claimed in claim 17, wherein the range of frequencies is swept in a decreasing manner.

19: A defrosting installation comprising:
a part to be defrosted;
an actuator including a stationary portion and a movable portion configured to alternately move away from and move towards the stationary portion, the movable portion of the actuator being configured, when it moves away from the stationary portion, to push a loading portion of the part to be defrosted to deform the part to be defrosted;
wherein the movable portion of the actuator and the loading portion of the part to be defrosted are not connected to one another, such that the loading portion of the part to be defrosted cannot pull the movable portion of the actuator to move it away from the stationary portion.

20: The defrosting installation as claimed in claim 19, wherein the actuator comprises a piezoelectric structure configured to deform in response to an electrical signal to move the movable portion of the actuator with respect to the stationary portion.

21: The defrosting installation as claimed in claim 19, wherein the movable portion of the actuator comprises a rounded face configured to push the loading portion of the part to be defrosted.

22: The defrosting installation as claimed in claim 19, further comprising a device controlling the actuator configured to alternately move the movable portion of the actuator away from and towards the stationary portion at a frequency sweeping a predetermined range of frequencies at least once in the course of a time.

23: The defrosting installation as claimed in claim 22, wherein the range of frequencies is swept in a decreasing manner.

24: A method for configuring a defrosting installation as claimed in claim 22 or a defrosting installation comprising a part to be defrosted and a device for defrosting the part to be defrosted, the method comprising:
determining modal frequencies of eigenmodes of the part to be defrosted;
selecting at least one of the modal frequencies;
determining a range of frequencies comprising the modal frequency or frequencies selected, but not the modal frequencies lower than a smallest selected modal frequency or greater than a highest selected modal frequency;
configuring the control device to be able to control the actuator to alternately move the movable portion of the actuator away from and towards the stationary portion at a frequency sweeping a range of frequencies at least once in the course of a time.
